(19) United States
(12) Patent Application Publication
(10) Pub. No.: US 2024/0311169 A1
(43) Pub. Date: Sep. 19, 2024

(54) RESOURCE ALLOCATION USING VIRTUALIZED ENHANCED RESOURCES

(71) Applicant: International Business Machines Corporation, Armonk, NY (US)

(72) Inventors: QI LIANG, SHANGHAI (CN); Li Ping Hao, BEIJING (CN); Cheng Cheng Dong, BEIJING (CN); Yi Xuan Zhang, Zhangjiang (CN); Xiao Feng Ren, BEIJING (CN); Gui Yu Jiang, SHANGHAI (CN); Dong Ma, Beijing (CN); Hao Jue Wang, Beijing (CN)

(21) Appl. No.: 18/183,214

(22) Filed: Mar. 14, 2023

(51) Int. Cl. G06F 9/455

(52) U.S. Cl. CPC G06F 9/45558; G06F 2009/4557; G06F 2009/45591

(57) ABSTRACT

Embodiments of the invention provide a computer system that includes a central processing unit (CPU) associated with a host computer. The CPU includes CPU functionality and on-board enhanced CPU functionality. The CPU further includes a virtualized first instance of the CPU comprising an enabled virtualized first instance of the CPU functionality; and a non-enabled virtualized first instance of the on-chip enhanced CPU functionality. The CPU further includes a virtualized second instance of the CPU comprising an enabled virtualized second instance of the CPU functionality; and an enabled virtualized second instance of the on-chip enhanced CPU functionality.

### BACKGROUND

The present invention relates in general to the administration and control of connected computing devices. More specifically, the present invention relates to computer systems, computer-implemented methodologies, and computer program products operable to allocate on-chip enhanced resources (e.g., accelerator resources) of a processor by virtualizing the on-chip enhanced resources and the processor.

In computing, a virtual machine (VM) is an operating system (OS) or application environment installed on software that imitates dedicated hardware. The end user has the same experience using a VM as they would have using a standard OS on dedicated hardware. Specialized software called a hypervisor or a virtual machine manager (VMM) emulates the client/server central processing unit (CPU), memory, hard disk, network and other hardware resources completely. This enables the VMM to emulate multiple virtual hardware platforms that are isolated from each other, thus allowing multiple different VMs to run multiple different OSs on the same underlying physical host. Because a VM uses physical hardware more efficiently, it is often implemented in large, multiple-server computing environments to reduce the amount of required physical hardware, which lowers hardware and associated maintenance costs and reduces power and cooling demands.

Hardware acceleration is the use of computer hardware designed to perform specific functions more efficiently when compared to software running on a general-purpose CPU. Any transformation of data that can be calculated in software running on a generic CPU can also be calculated in custom-made hardware, or in some mix of both.

### SUMMARY

Embodiments of the invention provide a computer system that includes a central processing unit (CPU) associated with a host computer. The CPU includes CPU functionality and on-board enhanced CPU functionality. The CPU further includes a virtualized first instance of the CPU comprising an enabled virtualized first instance of the CPU functionality; and a non-enabled virtualized first instance of the on-chip enhanced CPU functionality. The CPU further includes a virtualized second instance of the CPU comprising an enabled virtualized second instance of the CPU functionality; and an enabled virtualized second instance of the on-chip enhanced CPU functionality.

Embodiments are further directed to computer-implemented methods and/or a computer program product having substantially the same features and functionality as the computer system described above.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts a simplified block diagram illustrating a system according to embodiments of the invention;

FIG. 2 depicts a simplified block diagram illustrating a CPU having multiple cores and on-chip enhanced CPU functionality according to embodiments of the invention;

FIG. 3 depicts a table illustrating examples of virtualized CPU functionality and virtualized on-chip enhanced CPU functionality according to embodiments of the invention;

FIG. 4 depicts a flow diagram illustrating a methodology in accordance with embodiments of the invention;

FIG. 5 depicts a simplified block diagram illustrating a system according to embodiments of the invention;

FIG. 6 depicts a flow diagram illustrating a methodology in accordance with embodiments of the invention;

FIG. 7 depicts a simplified block diagram illustrating a filtering capability according to embodiments of the invention; and

FIG. 8 depicts details of an exemplary computing environment operable to implement various aspects of the invention.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

Turning now to an overview of technologies that are relevant to aspects of the invention, virtualization is a combination of software and hardware features that creates virtual CPUs (vCPUs) or virtual systems-on-chip (vSoC). These vCPUs or vSoCs are generally referred to as virtual machines (VM). In general, a vCPU represents a portion or share of the underlying, physical CPU that is assigned to a particular VM. Each VM is an abstraction of the physical CPU or SoC, complete with its view of the interfaces, memory and other resources within the physical CPU/SoC. Virtualization provides the required level of isolation and partitioning of resources to enable each VM. Each VM is protected from interference from another VM. The virtualization layer is generally called the virtual machine manager (VMM).

As previously noted herein, hardware acceleration is the use of computer hardware designed to perform specific functions more efficiently when compared to software running on a general-purpose CPU. Any transformation of data that can be calculated in software running on a generic, general-purpose CPU can also be calculated in custom-made hardware, or in some mix of both. Computer hardware designed to perform specific functions more efficiently when compared to software running on a general-purpose CPU is referred to as an accelerator or an offload engine. Accelerators can be provided on-chip, and the on-chip accelerator portion of a CPU is referred to herein the enhanced CPU functionality portion (or on-chip enhanced resources) of the CPU. Accelerators can be designed to significantly improve the performance of certain workloads, examples of which include artificial intelligence (AI) tasks, machine learning (ML) tasks, graphics-related tasks, data compression, cryptography, natural language processing (NLP) tasks, and the like. Accelerators can be a separate component attached to a processor, or can be integrated directly into the processor sometimes in the form of an instruction-set architecture (ISA) extension. An ISA is part of the abstract model of a computer that defines ho the CPU is controlled by the software. The ISA acts as an interface between the hardware and the software, specifying both what the processor is capable of doing as well as how it gets done. A device that executes instructions described by that ISA, such as a CPU, is called an implementation.

In situations where data processing services are provided to customers over network connections (including, for example, through a cloud computing environment), it is necessary to allocate processing resources to customers in response to customer requests to access such resources in order to perform one or more customer tasks. In a cloud computing system, compute service components (e.g., the Nova service in OpenStack®) control and manage compute resources, including the virtualized compute resources. Known cloud computing systems have shortcomings in that they do not in many instances allocate accelerator resources in an efficient manner, for example, allocating CPU accelerator resources together with vCPU resources to customers who do not need accelerator resources; forcing customers who need accelerator resources to compete for allocation of such resources; and not accurately tracking customer usage of CPU accelerator resources so that customers who use CPU accelerator resources can be differentiated from customers who do not use CPU accelerator resources.

Turning now to an overview of aspects of the invention, embodiments of the invention provide computer systems, computer-implemented methodologies, and computer program products operable to efficiently and consistently allocate and track CPU resources and on-chip enhanced CPU resources (e.g., accelerator resources). The on-chip enhanced CPU resources are designed to significantly improve the performance (e.g., speed and/or reliability) of certain workloads or tasks. Examples of such workloads include AI tasks, ML tasks, graphics-related tasks, data compression, cryptography, NLP tasks, and the like. In embodiments of the invention, CPU resources are allocated by virtualizing various combinations of the CPU resources and the on-chip enhanced CPU resources; and using a virtualized-resource matching (VRM) operation to match each resource request with an appropriate virtualized resource. In embodiments of the invention, a task is associated with the resource request, and the VRM operation includes selecting the virtualized CPU resource and/or the virtualized enhanced CPU resource based at least in part on the task. For example, where the task is a cryptographic task, the VRM operation selects a virtualized enhanced CPU resource operable to perform cryptographic tasks (e.g., encryption and/or decryption). Similarly, where the task is a routine operation (e.g., an arithmetic operation) that can be effectively and efficiently satisfied by (or matched to) CPU functionality, the VRM operation selects a virtualized CPU resource operable to perform routine operations (e.g., arithmetic operations). In embodiments of the invention, the virtualized CPU resources are distributed in various quantities among a variety of hosts, and a task and a resource quantity are associated with the resource request. In this scenario, the VRM operation includes selecting the combination of virtualized CPU resource and/or virtualized enhanced CPU resource based on the task, along with selecting a host location having an available combination of the matched virtualized resources that are available (i.e., not occupied or scheduled) to perform the task. For example, where the task is a cryptographic task that requires five (5) instances of virtualized enhanced CPU resource operable to perform cryptographic tasks (e.g., encryption and/or decryption), the VRM operations would first match the cryptographic task to virtualized cryptographic resources, and then match the task to a host having five (5) instances of virtualized cryptographic enhanced CPU resource that are available for being scheduled to perform that cryptographic task.

Any suitable virtualization methodology can be used to virtualize various combinations of the CPU resources and the on-chip enhanced CPU resources in accordance with embodiments of the invention. In some embodiments of the invention, the virtualization methodology includes creating the virtualized enhanced resource by selecting setting the appropriate CPU flags. In some embodiments of the invention, the complete CPU (including the enhanced CPU resources) are virtualized, and flags are set in the virtualized complete CPU that enable or disable (i.e., non-enable) the CPU and accelerator functions in any desired combination, thereby creating the various combinations of the CPU functionality alone; the CPU functionality combined with various combinations of the enhanced CPU functionality; and various combinations of the enhanced CPU functionality (e.g., AI resources alone; AI resources combined with data compression/decompression resources; data compression/decompression resources alone; and the like). Utilizing the CPU flags ensure that a portion of the CPU reserved for one type of resource functionality will not be used for another type of resource functionality. For example, a core for virtualized AI resource functionality cannot be used for virtualized data compression/decompression functionality.

Because the CPU resources and the enhanced CPU resources are virtualized, a scheduler can be configured to perform the VRM operations. In some embodiments of the invention, the scheduler can be implemented as part of a VMM used to generate and/or control the VMs that result from virtualizing various combinations of the CPU resources and the on-chip enhanced CPU resources.

In embodiments of the invention, the VRM operation further includes using the selected resource (the virtualized CPU resource and/or the virtualized enhanced CPU resource) to fulfill the resource request. In embodiments of the invention, the VRM operation further includes recording the specific customer that generated the resource request (or customer request); further recording a usage measurement (e.g., based on time) of the virtualized CPU resource and/or the virtualized enhanced CPU resource while fulfilling the resource request; and matching the recorded usage to the customer that requested the resource. As previously noted, in embodiments of the invention, the virtualized enhanced CPU resources can include multiple types of virtualized enhanced CPU resources, including, for example, AI resources operable to perform AI tasks; ML resources operable to perform ML tasks; graphics-related resources operable to perform graphics-related tasks; data compression/decompression resources operable to perform data compression/decompression task; NLP resources operable to perform NLP tasks; and the like. Accordingly, for customer A who used no virtualized enhanced CPU resources, a report can be generated that accurately identifies that customer A used no virtualized enhanced CPU resources over a predetermined time period (e.g., the month of March). Similarly, for customer B who used virtualized AI and cryptographic enhanced CPU resources, a report can be generated that accurately identifies that customer B used virtualized AI and cryptographic enhanced CPU resources, as well as identifying the usage measurement (e.g., fifty (50) hours of resource time used during the month of March) associated with customer B's usage of virtualized AI and cryptographic enhanced CPU resources.

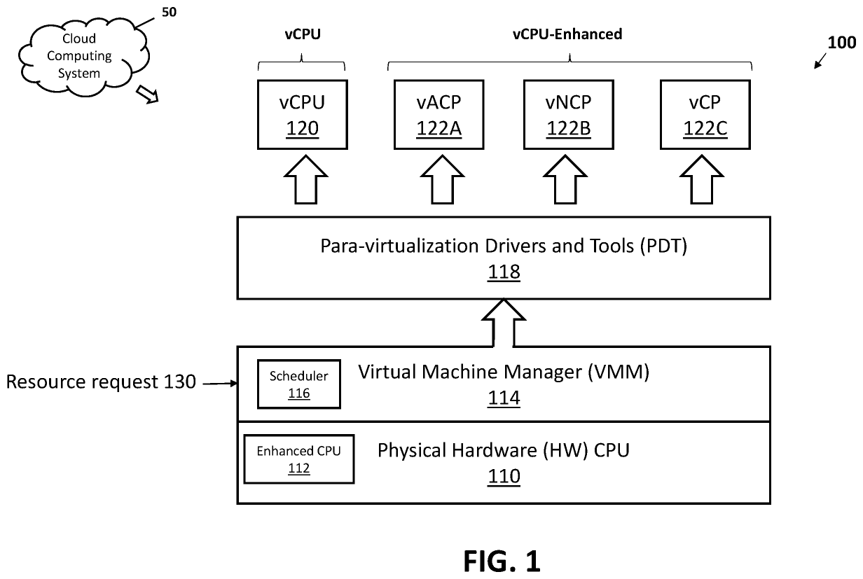

Turning now to a more detailed description of the embodiments of the invention, FIG. 1 depicts a block diagram illustrating a simplified exemplary host computing system 100 capable of implementing one or more embodiments of the invention. System 100 includes a host physical hardware (HW) device, hereinafter CPU 110, which can be in the form of a general purpose CPU having on-chip enhanced CPU resources 112. The on-chip enhanced CPU resources 112 are designed to significantly improve the performance (e.g., speed and/or reliability) of certain workloads or tasks performed by the CPU 110. Examples of such workloads include AI tasks, ML tasks, graphics-related tasks, data compression, cryptography, NLP tasks, and the like. In some embodiments of the invention, the enhanced CPU resources 112 can be external to the CPU 110 but sufficiently close to the CPU 110 that the enhanced CPU resources 112 can be virtualized with the CPU 110.

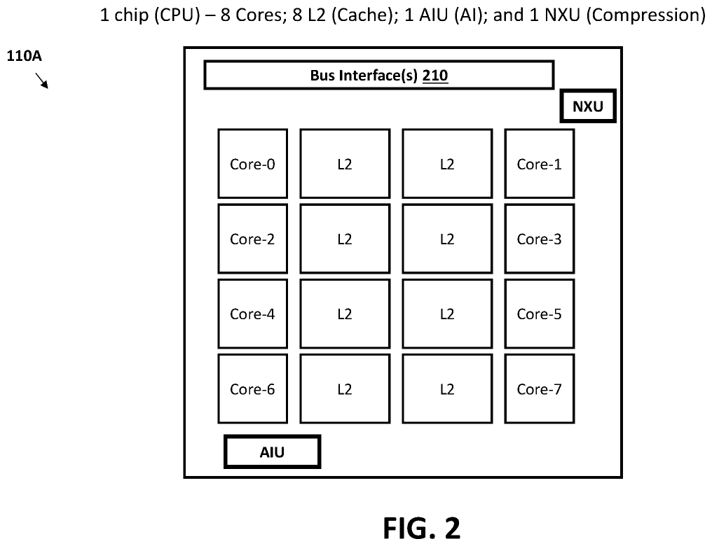

In embodiments of the invention, the CPU 110 can be implemented as one or more CPUs, and each of the one or more CPUs can be implemented as a multi-core processor. In general, a multi-core processor is a microprocessor on a single integrated circuit with two or more separate processing units, called cores, each of which reads and executes program instructions. The instructions are ordinary CPU instructions (such as add, move data, and branch) but the single processor can run instructions on separate cores at the same time, increasing overall speed for programs that support multithreading or other parallel computing techniques. Manufacturers typically integrate the cores onto a single integrated circuit die (known as a chip multiprocessor or CMP) or onto multiple dies in a single chip package. Core count can range from relatively small numbers (e.g., eight (8)) up to several dozen. For specialized chips, core count can reach ten thousand (10,000) or more. A non-limiting example of a multi-core processor implementation of the CPU 110 is shown in FIG. 2 as a multi-core processor 110A having multiple cores (Core-0 through Core-7), multiple instances of cache memory (L2), a bus interface 210, and two instances of the enhanced CPU resources 112 (shown in FIG. 2 as “AIU” (artificial intelligence functionality) and “NXU” (data compression functionality)). The on-chip enhanced CPU resource AIU and NXU can be implemented either inside a given one of the multiple cores (e.g., Core-0) and dedicated for the given one of the multiple cores, or outside the multiple cores and thus shared by one or more of the multiple cores. For ease of illustration and description, descriptions herein of virtualization operations applied at the CPU-level (e.g., virtualization operation applied to the CPU 110) also apply to virtualization operations applied at the core-level of the CPU 110 (e.g., virtualization operations applied to each core (Core-0 through Core-7) of the multi-core processor 110A).

Returning to FIG. 1, the system 100 further includes a host virtual machine manager (VMM) module 114, a host para-virtualization drivers and tools (PDT) module 118, one instance of a virtualization of the CPU resource (i.e., a generl purpose CPU) 110 (shown as vCPU 120), two instances of a virtualization of the enhanced CPU resources 112 (shown as vACP 122A and vNCP 122B), and one instance of a virtualization of the CPU resource 110 having a virtualization of the enhanced CPU resource 112 (shown as vCP 122C), configured and arranged as shown. More specifically, the vACP 122A represents virtualized AIU-accelerated CPU resources; and the vNCP 122B represents NXU-accelerated CPU resources. In accordance with aspects of the invention, the VMM module 114 includes a scheduler 116 operable to receive or access resource requests 130. In some embodiments of the invention, functionality of the VMM module 114 and/or the scheduler 116 can include OpenStack® software. OpenStack is an open source platform that uses pooled virtual resources to build and manage private and public clouds (e.g., cloud computing system 50 shown in FIG. 1). The components in the OpenStack platform, handle the core cloud-computing services of compute, networking, storage, identity, and image services. OpenStack is essentially a series of commands known as scripts. The scripts are bundled into packages called components that relay tasks that create cloud environments. In order to create those environments, OpenStack relies on virtualization (e.g., the VMM module 114) that creates a layer of virtual resources abstracted from hardware, along with a bas operating system (OS) that carries out commands given by OpenStack scripts. Thus, although OpenStack itself does not virtualize resources, it uses them to build clouds. Likewise, OpenStack also does not execute commands but rather relays them to the base OS. All 3 technologies—OpenStack, virtualization, and the base OS—must work together.

Continuing with FIG. 1, in accordance with aspects of the invention, the vCPU-Enhanced can be implemented as a vACP 122A, a vNCP 122B, and a vCP 122C, configured and arranged as shown. In embodiments of the invention, the CPU 110 includes a processor system and memory circuits on which the host VMM module 114 runs. Host VMM module 114 is known as a type I hypervisor configuration because host VMM module 114 runs directly on host CPU 110. In a type II hypervisor configuration, a standard OS is installed directly on host CPU 110, and the host VMM module 114 would be loaded on top of the standard OS. After the one instance of a virtualization of the CPU resource 110 (shown as vCPU 120), the two instances of a virtualization of the enhanced CPU resources 112 (shown as vACP 122A and vNCP 122B), and the one instance of a virtualization of the CPU resource 110 having a virtualization of the enhanced CPU resource 112 (shown as vCP 122C) are virtualized by host VMM module 114, host PDT module 118 is installed between the vCPU/vCPU-Enhanced and the host VMM module 114. Host PDT module 118 is a set of tools that provide operations and drivers for the vCPU/vCPU-Enhanced to run more optimally.

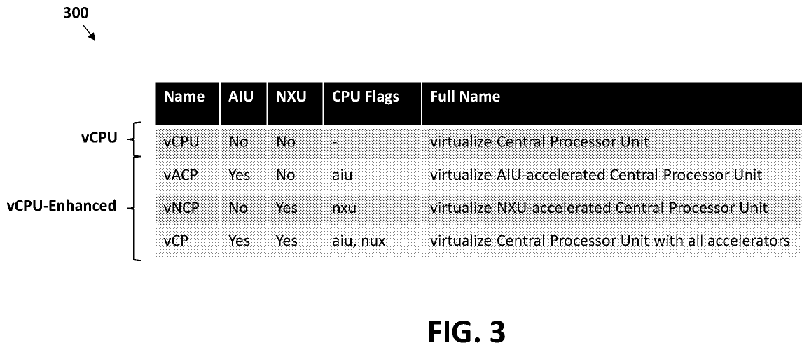

FIG. 3 depicts a table 300 illustrating additional details of the one instance of a virtualization of the CPU resource 110 (shown as vCPU 120), the two instances of a virtualization of the enhanced CPU resources 112 (shown as vACP 122A and vNCP 122B), and the one instance of a virtualization of the CPU resource 110 having a virtualization of the enhanced CPU resource 112 (shown as vCP 122C). In some embodiments of the invention, the various virtualizations (vCPU and vCPU-Enhanced) are generated by virtualizing the complete CPU 110 (including the enhanced CPU resources 112), and setting flags in the virtualized complete CPU 110 that enable or disable (i.e., non-enable) the CPU and accelerator functions in any desired combination, thereby creating the various variants of the vCPU/vCPU-Enhanced. As shown in the table 300, for the vCPU (i.e., the vCPU 120 shown in FIG. 1), the flags for AIU and NXU are disabled, so the only functionality in vCPU is the general CPU functionality of the CPU 110 (shown in FIG. 1). For the vACP (i.e., the vACP 122A shown in FIG. 1), the flag for AIU is enabled, and the flag for NXU functionality are disabled (or non-enabled), so the only enhanced functionality in vACP is the functionality of the “AIU” (shown in FIG. 2). For the vNCP (i.e., the vNCP 122B shown in FIG. 1), the flags for AIU functionality are disabled, and the flag for NXU functionality is enabled, so the only enhanced functionality in vNCP is the functionality of the “NXU” (shown in FIG. 2). For the vCP (i.e., the vCP 122C shown in FIG. 1), the flags for AIU functionality, and NXU functionality are enabled, so the functionality in vCP is the combined functionality of the CPU 110, the “AIU” (shown in FIG. 2), and the “NXU” (shown in FIG. 2).

Although the table 300 illustrates examples where the enhanced CPU resources 112 are implemented as AIU and/or NXU, embodiments of the invention can be applied to a variety of enhanced CPU resources, including any of the implementations of the enhanced CPU resources 112 described herein. Additionally, although 4 example combinations of the virtualized CPU resources and the virtualized enhanced CPU resources are shown in table 300, embodiments of the invention can generate any combination of virtualized CPU resources and virtualized enhanced CPU resources.

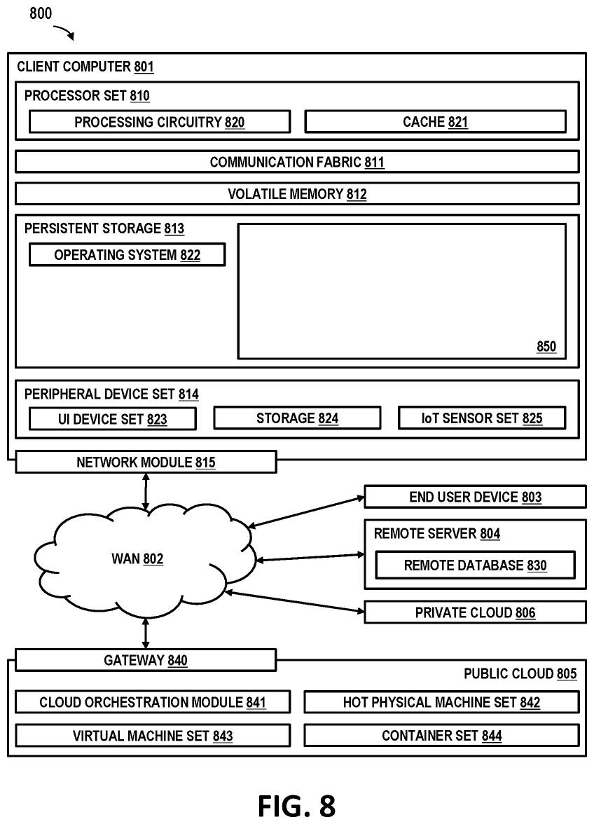

A cloud computing system 50 is in wired or wireless electronic communication with the system 100. The cloud computing system 50 can supplement, support or replace some or all of the functionality (in any combination) of the components of the system 100. Additionally, some or all of the functionality of the components of the system 100 can be implemented as a node of the cloud computing system 50. Additional details of cloud computing functionality that can be used in connection with aspects of the invention are depicted by the computing environment 800 shown in FIG. 8 and described in greater detail subsequently herein.

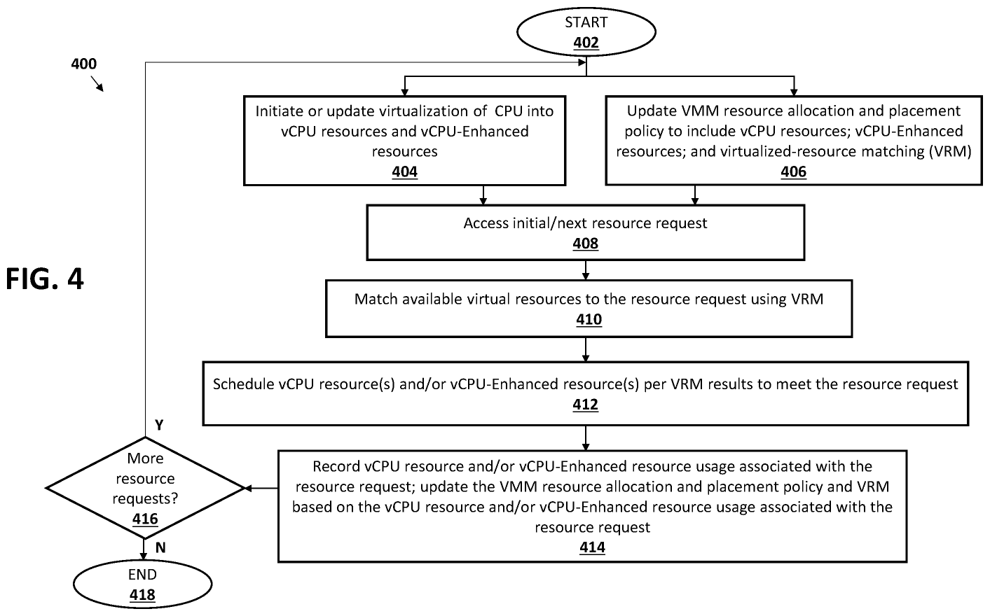

FIG. 4 depicts a flow diagram illustrating a methodology 400 in accordance with the embodiments of the invention. More specifically, the methodology 400 depicts operations performed by the system 100 (shown in FIG. 1) according to one or more embodiments of the invention. In some embodiments of the invention, the methodology 400 can also be applied to an implementation of the system 100 wherein the CPU 110 is implemented as the multi-core processor 110A (shown in FIG. 2). In embodiments of the invention where the CPU 110 is implemented as the multi-core processor 110A, multiple instances of the methodology 400 can be applied substantially concurrently on a per core basis to the multi-core processor 110A. In embodiments of the invention, where the CPU 110 is implemented as the multi-core processor 110A, a set of virtualized resources (e.g., any combination of vCPU and vCPU-Enhanced shown in FIG. 1) is provided for (and assigned to) each core (Core-0 through Core-7). The operations of system 100 are described below with reference to both the methodology 400 shown in FIG. 4 and, where appropriate, the system 100 shown in FIG. 1.

The methodology 400 begins at block 402 and moves to blocks 404, 406, which are performed substantially in parallel. At block 404, the system 100 is used to initiate or update a virtualization of the CPU resource 110 (including the enhanced CPU resources 112) into vCPU (e.g., vCPU 120 shown in FIG. 1) and vCPU-Enhanced (e.g., vACP 122A, vNCP 122B, vCP 122C shown in FIG. 1). At block 406, a resource and placement policy of the VMM module 114 is updated to include vCPU resources and vCPU-Enhanced resources that are currently available. In the initial iteration of the methodology 400, the allocation and placement policy, as well as the VRM operations, are based on the initial set up of computer system for cloud computing at block 404. In subsequent iterations of the methodology 400, the allocation and placement table and the VRM operation also includes any updates to the system 100 for cloud computing (i.e., updates to the vCPU resource and/or vCPU-Enhanced resource usage associated with the resource request) and the VRM that are generated downstream at block 414.

An initial or next resource request (e.g., resource request 130 shown in FIG. 1) is received or accessed at block 408, and at block 410 the VRM as updated or generated at block 406 is applied to the results of the operations at blocks 404, 408 to match the available virtual resources (e.g., vCPU 120, vACP 122A, vNCP 122B, vCP 122C shown in FIG. 1) to the resource request. In embodiments of the invention, a task is associated with the resource request, and the VRM operation includes selecting one or more of vCPU and/or vCPU-Enhanced (shown in FIG. 1) based at least in part on the task. For example, where the task is a data compression task requesting vNCP 122B (shown in FIG. 1), the VRM operation selects vNCP 122B (shown in FIG. 1) to perform the data compression tasks associated with the resource request. It is noteworthy that the vCP 122C (shown in FIG. 1) could also perform the data compression task associated with the resource request. However, using vCP 122C to perform the data compression task would reduce efficiency because the AIU functionality associated with vCP 122C would be allocated to the resource request but would not be used in performing the data compression tasks associated with resource request. Thus, the allocated but unused AIU functionality of vCP 122C would also not be available to perform AI tasks associated with other resource requests that are being serviced by other cores (e.g., Core-0 through Core-7 shown in FIG. 2).

Similarly, where the task is a routine operation (e.g., an arithmetic operation) that can be effectively and efficiently satisfied by (or matched to) general-purpose CPU functionality, the VRM operation selects vCPU 120 (shown in FIG. 1) to perform the routine task associated with the resource request. It is noteworthy that any one of the vACP 122A, the vNCP 122B, and/or the vCP 122C (shown in FIG. 1) could also perform the routine task associated with the resource request. However, using any one of the vACP 122A, the vNCP 122B, and/or the vCP 122C to perform the routine task would reduce efficiency because the AIU and NXU functionalities associated with any one of the vACP 122A, the vNCP 122B, and/or the vCP 122C would be allocated to the resource request but would not be used in performing the routine task associated with resource request. Thus, the unused AIU and/or NXU functionalities allocated to the resource request would also not be available to perform AI and/or data compression tasks associated with other resource requests that are being serviced by other cores (e.g., Core-0 through Core-7 shown in FIG. 2).

In some embodiments of the invention, the resource request can include a quantity of resources needed to satisfy the resource request, and the VRM can include a determination of the portion of the CPU with a quantity of available resources to satisfy or match the requested quantity of resources. For example, in some embodiments of the invention, twenty (20) instances of the vCP 122C can be provided by the system 100; the resource request can specify that it needs ten (10) instances of the vCP 122C to fulfill the resource request; and the VRM can determine that the CPU 110 has ten (10) available instance of the vCP 122C (i.e., vCP resources that have not been allocated or scheduled) that can satisfy the resource request and allocates ten (10) of the twenty (20) available vCP 122C to the resource request. In some embodiments of the invention, eight (8) instances of the vCP 122C can be provided; the resource request can specify that it needs ten (10) instances of the vCP 122C to fulfill the resource request; and the VRM can determine that CPU 110 can only partially satisfy the resource request. In this case, the VRM can allocate the eight (8) instances of the vCP 122C to the resource request then satisfy the remaining portion of the resource request by identifying two (2) available vCP instances in another CPU (not shown) of the system 100. Alternatively, the VRM can determine that it is more efficient to satisfy the resource request from a single CPU and searches other CPUs of the system 100 (now shown) to locate ten (10) available vCP to satisfy the resource request.

At block 412, the methodology 400 schedules the virtualized resources allocated per the VRM operation and uses the allocated virtualized resources to efficiently and effectively perform the task(s). At block 414, the methodology 400 (e.g., using additional VRM operation) records the specific customer that generated the resource request (or customer request); further records a usage measurement (e.g., based on quantity (e.g., number of virtualized resources) and/or time of the virtualized CPU resource (e.g., vCPU 120 shown in FIG. 1) and/or the virtualized enhanced CPU resource (e.g., vACP 122A, vNCP 122B, vCP 122C shown in FIG. 1) while fulfilling the resource request; and matching the recorded usage to the customer that requested the resource. Accordingly, for customer A who used no virtualized enhanced CPU resources (e.g., vACP 122A, vNCP 122B, vCP 122C shown in FIG. 1), a report can be generated that accurately identifies that customer A used no virtualized enhanced CPU resources. Similarly, for customer B who used four (4) instances of virtualized AI and data compression enhanced CPU resources, a report can be generated that accurately identifies that customer B used four (4) instances of virtualized AI and data compression enhanced CPU resources, as well as identifying the usage measurement (e.g., virtualized instances and/or time) associated with customer B's usage of virtualized AI and data compression enhanced CPU resources. Block 414 also updates the VRM by updating the vCPU and vCPU-Enhanced resources that are available and the vCPU and vCPU-Enhanced resources that are unavailable.

Subsequent to the operations at block 414, the methodology 400 moves to decision block 416 to determine whether or not there are more resource requests. If the answer to the inquiry at decision block 416 is no, the methodology 400 moves to block 418 and ends. If the answer to the inquiry at decision block 416 is yes, the methodology 400 returns to the inputs to blocks 404, 406 to perform another iteration of the operations at blocks 404, 406, 408, 410, 412, 414, 416.

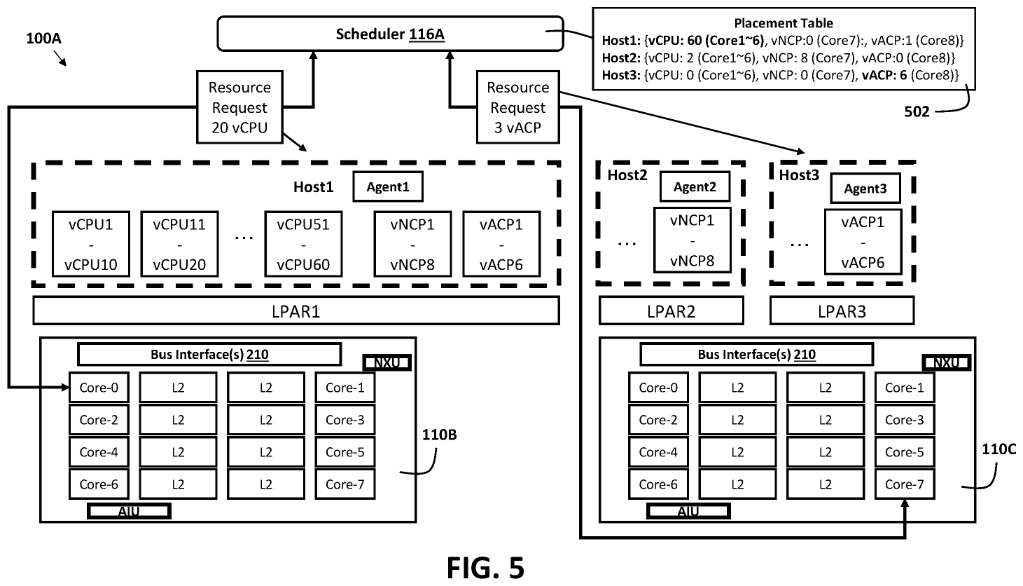

FIG. 5 depicts a block diagram illustrating another simplified exemplary host computing system 100A capable of implementing one or more embodiments of the invention. The system 100A corresponds to the system 100 (shown in FIG. 1) but provides additional example implementation details in accordance with embodiments of the invention. Like the system 100, the system 100A can be in communication with and coupled to the cloud computing system 50 (shown in FIG. 1). As shown, the system 100A includes multi-core processors 110B, 110C; logical partitions (LPARs) shown as LPAR1, LPAR2, LPAR3; a first host Host1; a second host Host2; a third host Host3; and a scheduler 116A, configured and arranged as shown. Host1 includes suites of virtualized resources for one or more of Core-0 through Core-7 of the multi-core processor 110B. As an example, for the multi-core processor 110B, Core-0 through Core-5 include a suite of virtualized resources that include vCPU1-vCPU60 virtualized in groups of ten (10) for Core-0 through Core-5; Core-6 includes a suite of virtualized resources that include vNCP1-vNCP8; and Core-7 includes a suite of virtualized resources that include vACP1-vACP6, configured and arranged as shown. Host2 includes suites of virtualized resources that include vNCP1-vNCP8 associated with one core. Host3 includes suites of virtualized resources that include vACP1-vACP6 associated with one core.

In the system 100A, the multi-core processors 110B, 110C correspond to the multi-core processor (e.g., CPU 110 shown in FIG. 1). The logical partitions (LPAR1, LPAR2, LPAR3) are each a division of a computer processor's memory and storage into multiple sets of resources so that each set of resources can be operated independently with its own OS instance and applications. The number of logical partitions that can be created depends on the system's processor model and resources available. Typically, logical partitions are used for different purposes such as database operation, client/server operation, and/or to separate test and production environments. Each logical partition can communicate with the other logical partitions as if the other logical partitions are in separate machines. Each of the hosts (Host1, Host2, Host3) includes an agent (Agent1, Agent2, Agent3) and a suite of virtualized resources that have been virtualized from the multi-core processors 110B, 110C. In general an agent is a service process that runs in the background and supervises the system or provides functionality to other processes. Use cases for agents include when a program needs to be available at all times and managed by the scheduler.

The scheduler 116A corresponds to the schedule 116 (shown in FIG. 1). In embodiments of the invention, the hosts (Host1, Host2, Host3) use agents (Agent1, Agent2, Agent3) to report their available vCPU and vCPU-Enhanced resources to the scheduler 116A. For example, Host1 reports that its available vCPU and vCPU-Enhanced resources include, inter alia, sixty (60) instances of vCPU1 to vCPU60; eight (8) instances from vNCP1 to vNCP8; and six (6) instances from vACP1 to vACP6. Host2 reports that its available vCPU and vCPU-Enhanced resources include, inter alia, eight (8) instances from vNCP1 to vNCP8. Host3 reports that its available vCPU and vCPU-Enhanced resources include, inter alia, six (6) instances from vACP1 to vACP6. The scheduler 116A uses the reports of available vCPU and vCPU-Enhanced resources received from the hosts to generate a placement table 502 that identifies the available vCPU and vCPU-Enhanced resources at the hosts. In operation, the scheduler 116A receives resource requests from users or customer that need access to resources to perform customer tasks. In the example depicted in FIG. 5, a first received resource request is for twenty (20) instances of vCPU; and a second resource request is for three (3) instances of vACP. In accordance with aspects of the invention, the scheduler 116A uses the placement table 502 and a VRM to determine that the first resource request is best satisfied by allocating twenty (20) of the sixty (60) vCPU instances at Host1 to the first resource request. Additionally, in accordance with aspects of the invention, the scheduler 116A uses the placement table 502 and a VRM to determine that the second resource request is best satisfied by allocating three (3) of the six (6) vACP instances at Host3 to the second resource request.

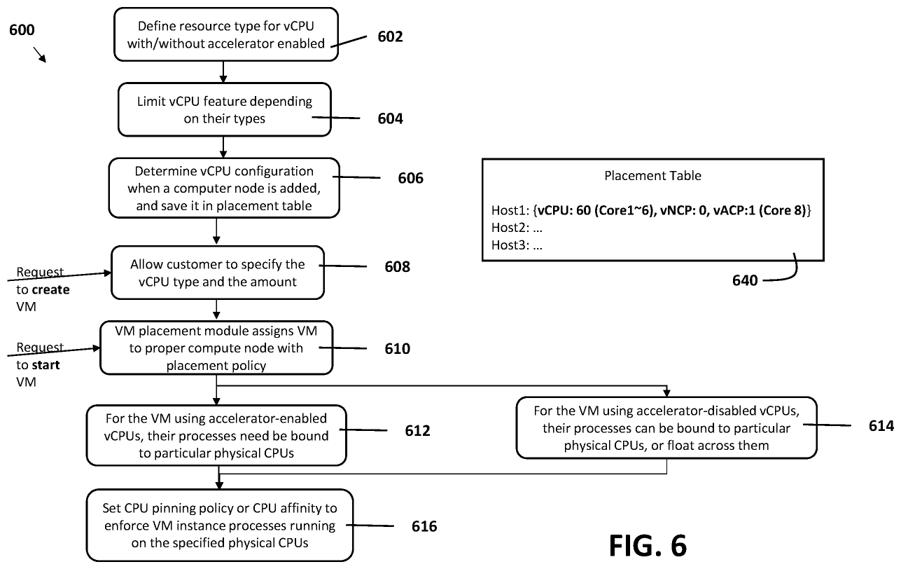

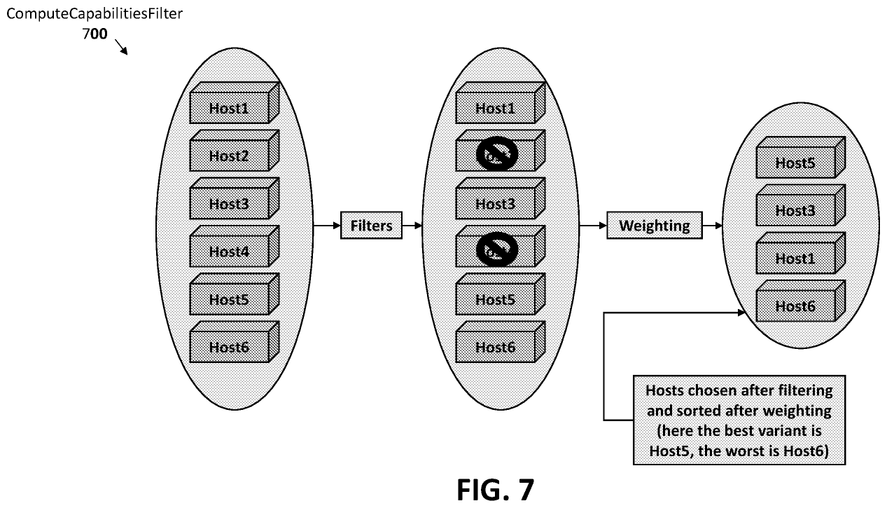

FIG. 6 depicts a flow diagram illustrating a methodology 600 in accordance with the embodiments of the invention. More specifically, the methodology 600 depicts operations that can be performed by the system 100A (shown in FIG. 5). In some embodiments of the invention, the methodology 600 depicts operations that can be implemented using the system 100 (shown in FIG. 1). The following description of the methodology 600 is provided primarily with reference to operations of the methodology 600 shown in FIG. 6 and components of the systems 100, 100A shown in FIG. 1 and FIG. 5. As shown in FIG. 6, at block 602, the methodology 600 defines the various resource types (i.e. vCPU 120; vACP 122A; vNCP 122B; and vCP 122C, shown in FIG. 1) for the virtualization of the CPUs 110, 110B, 110C with and/or without the enhanced/accelerator functionality enabled. In embodiments of the invention, the information used by the methodology 600 at block 602 can be defined by an administrator of the cloud computing system (e.g., system 50 shown in FIG. 1), which the systems 100, 100A belongs to. At block 604, the methodology uses flags (e.g., a CPU ID or the CPU flags shown in FIG. 3) to enable or disable (i.e., non-enable) various combinations of virtualized CPU functionality and virtualized enhanced CPU functionality on, for example, a virtualized instance of the CPUs 110, 110A, thereby creating the various resource types (i.e. vCPU 120; vACP 122A; vNCP 122B; and vCP 122C, shown in FIG. 1). At block 606, a compute node can be considered a computer system providing virtualized computing resources, like systems 100, 100A. Thus, at block 606, the methodology 600 determines the vCPU configurations when a VM is added, and the configuration is saved to the placement table 640. For example, at block 606, the methodology 600 determines how many instances of the vCPU 120; vACP 122A; vNCP 122B; and vCP 122C will be provided from the new added compute node, as well as the physical CPU and/or physical cores (e.g., CPU 100, 100A, 100B, 100C) to which the VMs will be bound. At block 608, the methodology 600 allows customer to create VMs by specifying vCPU types (i.e. vCPU 120; vACP 122A; vNCP 122B; and vCP 122C, shown in FIG. 1), and their amount. At block 610, the methodology 600 receives a request to start the VMs created at block 608, which corresponds to the first resource request (Resource Request for twenty (20) instances of vCPU) and the second resource request (Resource Request for three (3) instances of vACP) shown in FIG. 5. In embodiments of the invention, the scheduler 116A essentially uses the placement table 502, 640 to perform a VRM that matches the requested resource to a host best suited to provide the resources. In some embodiments of the invention, the VRM operations can be performed using the “ComputeCapabilitiesFilter” functionality of OpenStack software to determine the host best suited to provide the requested/required VM resources. FIG. 7 depicts a ComputerCapabilitesFilter 702 that can be used in connection with embodiments of the invention. The ComputerCapabilitesFilter 702 is new vCPU type aware filter that can be implemented using the scheduler 116A (which can be a Nova Scheduler of OpenStack) to determine a proper computer node to run the VM.

At blocks 612 and 614, to make the VM run efficiently, the VMs that use virtualized accelerator functionality are associated with or bound to their corresponding CPU (e.g., CPU 110 sown in FIG. 1) or to a particular core of its corresponding CPU (e.g., CPU 100A, 100B, 100C). This will prevent the case where a virtualized CPU without virtualized accelerator functionality runs on a CPU or CPU-core that is reserved for a virtualized CPU with virtualized accelerator functionality. Similarly, the VMs that use do not use virtualized accelerator functionality are associated with or bound to their corresponding CPU (e.g., CPU 100 sown in FIG. 1) or to a particular core of its corresponding CPU (e.g., CPU 100A, 100B, 100C). This will prevent the case where a virtualized CPU with virtualized accelerator functionality runs on a CPU or CPU-core that is reserved for a virtualized CPU without virtualized accelerator functionality. At block 616, all of the above-described restrictions are defined in the placement tables 502, 640 and enforced by the VRM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 depicts an example computing environment 800 that can be used to implement aspects of the invention. Computing environment 800 contains an example of an environment for the execution of at least some of the computer code involved in performing the inventive methods, such as improved resource allocation using virtualized enhanced resources (i.e., block 850). In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IOT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The phrases “in signal communication”, “in communication with,” “communicatively coupled to,” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer system comprising:
a central processing unit (CPU) associated with a host computer, wherein the CPU comprises CPU functionality and on-chip enhanced CPU functionality;
a virtualized first instance of the CPU comprising:
an enabled virtualized first instance of the CPU functionality; and
a non-enabled virtualized first instance of the on-chip enhanced CPU functionality; and
a virtualized second instance of the CPU comprising:
an enabled virtualized second instance of the CPU functionality; and
an enabled virtualized second instance of the on-chip enhanced CPU functionality.

2. The computer system of claim 1 further comprising a virtual machine manager (VMM) operable to process a resource request comprising a request to access one or more resources associated with the host computer, wherein the one or more resources associated with the host computer include the CPU, the virtualized first instance of the CPU, and the virtualized second instance of the CPU.

3. The computer system of claim 2, wherein the VMM is operable to, responsive to the resource request, perform a virtualized-resource matching (VRM) operation on the resource request and the one or more resources associated with the host computer.

4. The computer system of claim 3, wherein:
a task is associated with the resource request; and
the VRM operation comprises selecting the virtualized first instance of the CPU or the virtualized second instance of the CPU based at least in part on the task.

5. The computer system of claim 4, wherein the VRM operation further comprises:
fulfilling the resource request; and
recording a usage of the virtualized first instance of the CPU or the virtualized second instance of the CPU while fulfilling the resource request.

6. The computer system of claim 1, wherein:
the virtualized second instance of the CPU comprise multiple types of the virtualized second instance of the CPU; and
each of the multiple types of the virtualized second instance of the CPU is configured to enable one of multiple types of the virtualized second instance of the on-chip enhanced CPU functionality.

7. The computer system of claim 6, wherein the one of the multiple types of the virtualized second instance of the on-chip enhanced CPU functionality is selected from a group consisting of an accelerator on-chip enhanced CPU functionality and a compression on-chip enhanced CPU functionality.

8. A computer-implemented method of virtualizing and using a central processing unit (CPU), the computer-implemented method comprising:
providing a virtualized first instance of the CPU associated with a host computer; and
providing a virtualized second instance of the CPU associated with the host computer;
wherein the CPU comprises CPU functionality and on-board enhanced CPU functionality;
wherein the virtualized first instance of the CPU comprises:
an enabled virtualized first instance of the CPU functionality; and
a non-enable a virtualized first instance of an on-chip enhanced CPU functionality; and
wherein the virtualized second instance of the CPU comprising:
an enabled virtualized second instance of the CPU functionality; and
an enabled virtualized second instance of the on-chip enhanced CPU functionality.

9. The computer-implemented method of claim 8 further comprising providing a virtual machine manager (VMM) operable to process a resource request comprising a request to access one or more resources associated with the host computer, wherein the one or more resources associated with the host computer include the CPU, the virtualized first instance of the CPU, and the virtualized second instance of the CPU.

10. The computer-implemented method of claim 9, wherein the VMM is operable to, responsive to the resource request, perform a virtualized-resource matching (VRM) operation on the resource request and the one or more resources associated with the host computer.

11. The computer-implemented method of claim 10, wherein:
a task is associated with the resource request; and
the VRM operation comprises selecting the virtualized first instance of the CPU or the virtualized second instance of the CPU based at least in part on the task.

12. The computer-implemented method of claim 11, wherein the VRM operation further comprises:
fulfilling the resource request; and
recording a usage of the virtualized first instance of the CPU or the virtualized second instance of the CPU while fulfilling the resource request.

13. The computer-implemented method of claim 8, wherein:
the virtualized second instance of the CPU comprise multiple types of the virtualized second instance of the CPU; and
each of the multiple types of the virtualized second instance of the CPU is configured to enable one of multiple types of the virtualized second instance of the on-chip enhanced CPU functionality.

14. The computer-implemented method of claim 13, wherein the one of the multiple types of the virtualized second instance of the on-chip enhanced CPU functionality is selected from a group consisting of an accelerator on-chip enhanced CPU functionality and a compression on-chip enhanced CPU functionality.

15. A computer program product for virtualizing and using a central processing unit (CPU), the computer program product comprising a computer readable program stored on a computer readable storage medium, wherein the computer readable program, when executed on a processor, causes the processor to perform processor operations comprising:
providing a virtualized first instance of the CPU associated with a host computer; and
providing a virtualized second instance of the CPU associated with the host computer;
wherein the CPU comprises CPU functionality and on-board enhanced CPU functionality;
wherein the virtualized first instance of the CPU comprises:
an enabled virtualized first instance of the CPU functionality; and
a non-enabled virtualized first instance of an on-chip enhanced CPU functionality; and
wherein the virtualized second instance of the CPU comprises:
an enabled virtualized second instance of the CPU functionality; and
an enabled virtualized second instance of the on-chip enhanced CPU functionality.

16. The computer program product of claim 15, wherein the processor operations further comprise providing a virtual machine manager (VMM) operable to process a resource request comprising a request to access one or more resources associated with the host computer, wherein the one or more resources associated with the host computer include the CPU, the virtualized first instance of the CPU, and the virtualized second instance of the CPU.

17. The computer program product of claim 16, wherein the VMM is operable to, responsive to the resource request, perform a virtualized-resource matching (VRM) operation on the resource request and the one or more resources associated with the host computer.

18. The computer program product of claim 17, wherein:
a task is associated with the resource request;
the VRM operation comprises selecting the virtualized first instance of the CPU or the virtualized second instance of the CPU based at least in part on the task; and
the VRM operation further comprises fulfilling the resource request and recording a usage of the virtualized first instance of the CPU or the virtualized second instance of the CPU while fulfilling the resource request.

19. The computer program product of claim 15, wherein:
the virtualized second instance of the CPU comprise multiple types of the virtualized second instance of the CPU; and
each of the multiple types of the virtualized second instance of the CPU is configured to enable one of multiple types of the virtualized second instance of the on-chip enhanced CPU functionality.

20. The computer program product of claim 19. wherein the one of the multiple types of the virtualized second instance of the on-chip enhanced CPU functionality is selected from a group consisting of an accelerator on-chip enhanced CPU functionality and a compression on-chip enhanced CPU functionality.
